(19) United States
(12) Patent Application Publication
(10) Pub. No.: US 2025/0323386 A1
(43) Pub. Date: Oct. 16, 2025

(54) POWER STORAGE DEVICE

(71) Applicants: TOYOTA JIDOSHA KABUSHIKI KAISHA, Aichi-ken (JP); TOYOTA BATTERY CO., LTD., Shizuoka (JP)

(72) Inventors: Kazuhito KATO, Toyota-shi (JP); Yoshiro OBAYASHI, Toyota-shi (JP); Yosuke SHIMURA, Nagakute-shi (JP); Kenta MIYAHARA, Toyohashi-shi (JP); Takuya NOGUCHI, Toyota-shi (JP); Yuji KATAYAMA, Okazaki-shi (JP); Ryutaro SUZUKI, Hamamatsu-shi (JP); Masaya OGURA, Hamamatsu-shi (JP)

(21) Appl. No.: 19/066,157

(22) Filed: Feb. 28, 2025

(30) Foreign Application Priority Data
Apr. 12, 2024 (JP) 2024-064594

(51) Int. Cl. H01M 50/503; B60L 50/64; H01M 50/489; H01M 50/55; H01M 50/552

(52) U.S. Cl. CPC H01M 50/503; B60L 50/64; H01M 50/489; H01M 50/55; H01M 50/552; H01M 2220/20

(57) ABSTRACT

A power storage device includes a cell assembly including a plurality of power storage cells arranged in an X direction and a connection portion electrically connecting the power storage cells adjacent to each other in the X direction. A bent portion is provided between the power storage cells electrically connected by the connection portion.

### CROSS REFERENCE TO RELATED APPLICATIONS

This nonprovisional application is based on Japanese Patent Application No. 2024-064594 filed on Apr. 12, 2024 with the Japan Patent Office, the entire contents of which are hereby incorporated by reference.

### BACKGROUND

### Field

The present disclosure relates to a power storage device.

### Description of the Background Art

Japanese National Patent Publication No. 2023-502457 discloses a battery including a housing and a plurality of electrode assembly sets. The plurality of electrode assembly sets are provided in the housing. The plurality of electrode assembly sets are arranged in order along a first direction and are connected in series.

### SUMMARY

In the battery described in Japanese National Patent Publication No. 2023-502457, the plurality of electrode assembly sets (power storage cells) are connected in series in the first direction (arrangement direction) and thus, when a shock is applied to one of the electrode assembly sets, the shock may be easily transmitted to another one of the electrode assembly sets.

The present disclosure has been made to solve the above-described problem and an object thereof is to provide a power storage device capable of inhibiting transmission of a shock between a plurality of power storage cells arranged in an arrangement direction.

A power storage device according to an aspect of the present disclosure includes a cell assembly including a plurality of power storage cells arranged in an arrangement direction and a connection portion electrically connecting the power storage cells adjacent to each other in the arrangement direction. The power storage device includes a case that accommodates the cell assembly. A shock absorbing portion is provided between the power storage cells electrically connected by the connection portion.

In the power storage device according to the aspect of the present disclosure, as described above, the shock absorbing portion is provided between the power storage cells electrically connected by the connection portion. Thus, when a shock is applied to the power storage cell from the outside for example, the shock can be absorbed by the shock absorbing portion. As a result, transmission of the shock between the power storage cells electrically connected can be inhibited.

Each of the plurality of power storage cells may have a longitudinal direction in the arrangement direction. Such a configuration enables it to inhibit transmission of a shock between the power storage cells arranged in the longitudinal direction. As a result, application of the shock to a side (a surface) of the power storage cell in the lateral direction can be inhibited.

The shock absorbing portion may include a bent portion formed in the connection portion. Here, the bent portion is deformed more easily than a portion formed so as to be linear. Accordingly, since the bent portion can be easily deformed by the shock applied to the power storage cell, the shock can be effectively absorbed by the bent portion.

The cell assembly may include a first cell assembly and a second cell assembly adjacent to each other in an orthogonal direction orthogonal to the arrangement direction. The connection portion may include a first connection portion electrically connecting the power storage cells adjacent to each other in the arrangement direction in the first cell assembly, and a second connection portion electrically connecting the power storage cells adjacent to each other in the arrangement direction in the second cell assembly. The bent portion may include a first bent portion formed in the first connection portion and a second bent portion formed in the second connection portion. Such a configuration enables it to inhibit transmission of a shock between the power storage cells in each of the first cell assembly and the second cell assembly.

In the orthogonal direction, the first bent portion may be bent so as to project in a direction away from the second bent portion. Such a configuration enables it to easily inhibit contact of the first bent portion with the second bent portion.

In the orthogonal direction, the second bent portion may be bent so as to project in a direction away from the first bent portion. Such a configuration enables it to inhibit contact of the first bent portion with the second bent portion, more easily.

The power storage device may include an electrically insulating member disposed between the first bent portion and the second bent portion. Such a configuration enables it to easily inhibit short-circuiting of the first bent portion and the second bent portion.

The shock absorbing portion may include an expansion and contraction portion formed in the connection portion and capable of expanding and contracting in the arrangement direction. Such a configuration enables it to easily cause a shock from the outside to be absorbed by the expansion and contraction portion expanding and contracting in response to the shock from the outside.

The shock absorbing portion may include an elastic member disposed between the power storage cells electrically connected by the connection portion. Such a configuration enables it to cause a shock from the outside to be absorbed by the elastic member and thus, transmission of the shock between the power storage cells can be easily inhibited.

The plurality of power storage cells may include a first power storage cell and a second power storage cell electrically connected by a connection portion. The first power storage cell may include a first electrode terminal protruding toward the second power storage cell, the second power storage cell may include a second electrode terminal protruding toward the first power storage cell, and the first electrode terminal and the second electrode terminal may be electrically connected to each other by the connection portion. The first electrode terminal may include a first tapering portion tapering toward the second power storage cell, and the second electrode terminal may include a second tapering portion tapering toward the first power storage cell and connected to the first tapering portion. The shock absorbing portion includes a portion where the first tapering portion and the second tapering portion are connected to each other. Such a configuration enables it to easily disperse (release) force caused by a shock from the outside in a direction different from the direction of the force owing to the tapering shape (the inclined shape) of each of the first tapering portion and the second tapering portion. As a result, transmission of a shock between the power storage cells can be effectively inhibited.

The shock absorbing portion may include a damper disposed between the power storage cells electrically connected by the connection portion. Such a configuration enables it to cause a shock from the outside to be absorbed by the damper.

The shock absorbing portion may include a holding member that holds the connection portion. Such a configuration enables it to cause deformation (displacement) of the connection portion due to a shock from the outside to be inhibited by the holding member. As a result, transmission of a shock between the power storage cells due to deformation (displacement) of the connection portion can be inhibited.

The foregoing and other objects, features, aspects, and advantages of the present disclosure will become apparent from the following detailed description of the present disclosure, which will be understood in conjunction with the accompanying drawings.

### BRIEF DESCRIPTION OF THE DRAWINGS

FIG. 1 is a diagram illustrating a configuration of an electrically powered vehicle on which a power storage device according to an embodiment is mounted.

FIG. 2 is a perspective view illustrating a configuration of the power storage device according to the embodiment.

FIG. 3 is a diagram illustrating a configuration of a cell assembly in the power storage device according to the embodiment.

FIG. 4 is a partial perspective view illustrating, on an enlarged scale, an internal structure of the power storage device according to the embodiment.

FIG. 5 is an exploded perspective view illustrating a configuration of a power storage cell in the power storage device according to the embodiment.

FIG. 6 is a side view of the power storage device according to the embodiment, which is viewed from a side.

FIG. 7 is a cross-sectional view along line VII-VII in FIG. 6.

FIG. 8 is a cross-sectional view along line VIII-VIII in FIG. 6.

FIG. 9 is a diagram illustrating how a bent portion is deformed.

FIG. 10 is a partial cross-sectional view illustrating, on an enlarged scale, the vicinity of a connection portion according to a first variation of the embodiment.

FIG. 11 is a partial cross-sectional view illustrating, on an enlarged scale, the vicinity of a connection portion according to a second variation of the embodiment.

FIG. 12 is a partial cross-sectional view illustrating, on an enlarged scale, the vicinity of a connection portion according to a third variation of the embodiment.

FIG. 13 is a partial cross-sectional view illustrating, on an enlarged scale, the vicinity of a connection portion according to a fourth variation of the embodiment.

FIG. 14 is a cross-sectional view illustrating a configuration of a holding member in FIG. 13.

### DESCRIPTION OF THE PREFERRED EMBODIMENTS

Embodiments of the present disclosure are described with reference to the drawings. In the drawings referred to below, the same reference numerals are given to identical or equivalent members.

### Present Embodiment

### <Configuration of Power Storage Device>

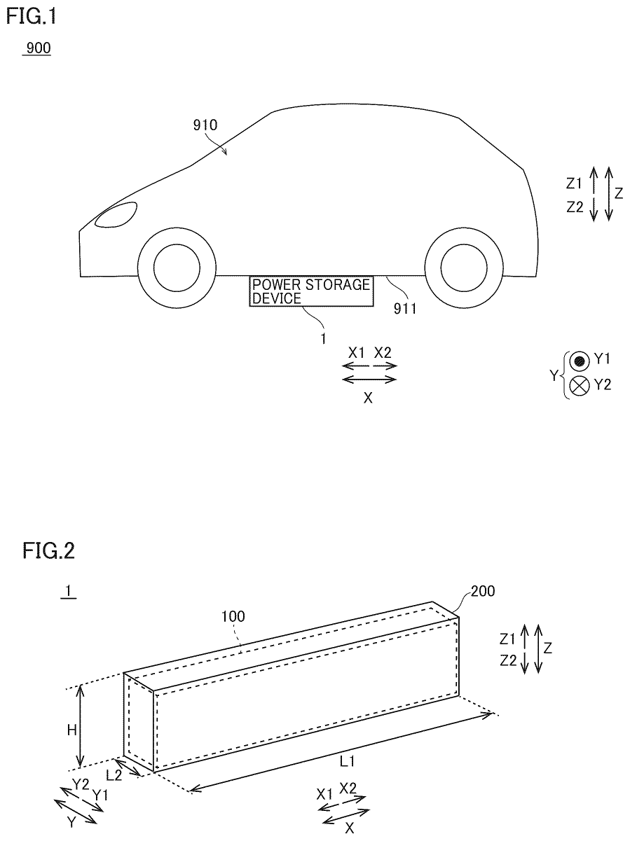

FIG. 1 is a diagram illustrating an electrically powered vehicle 900 where a power storage device 1 according to an embodiment of the present disclosure is mounted. Power storage device 1 stores power for driving electrically powered vehicle 900 for example.

An X direction, a Y direction, and a Z direction are herein orthogonal to each other. In the example shown in FIG. 1, the X direction and the Y direction are the front-rear direction and the left-right direction of the electrically powered vehicle, respectively. Specifically, the X1 side and the X2 side correspond to the front side and the rear side, respectively. The Y1 side and the Y2 side correspond to the left side and the right side, respectively. The Z direction is the vertical direction. Specifically, the Z1 side and the Z2 side correspond to the upper side and the lower side, respectively. The X direction is an example of the “arrangement direction” and the “longitudinal direction” according to the present disclosure. The Y direction is an example of the “orthogonal direction” according to the present disclosure.

Electrically powered vehicle 900 includes a vehicle body 910 in addition to power storage device 1. Vehicle body 910 includes an underbody 911. Underbody 911 is provided in a lower portion (a bottom portion) of vehicle body 910. Power storage device 1 is disposed on underbody 911. Specifically, power storage device 1 is fixed (fastened) to underbody 911 on the lower side (the Z2 side) of underbody 911.

As illustrated in FIG. 2, power storage device 1 includes a cell assembly 100 and a case 200. Cell assembly 100 is accommodated in case 200. Case 200 is made of, for example, aluminum. Power storage device 1 is provided with a plurality of cases 200 that each accommodate cell assembly 100. The plurality of cases 200 are stacked, for example, in the Y direction (the left-right direction of electrically powered vehicle 900). The direction in which cases 200 are stacked is not limited to the above-described example. In FIG. 2, only one case 200 is illustrated for simplification.

Case 200 is formed in a rectangular parallelepiped shape long in the X direction. Specifically, case 200 has a dimension L1 in the X direction and a dimension L2 in the Y direction. Dimension L1 is larger than dimension L2. Case 200 has a height H in the Z direction. Height H is smaller than dimension L1 and larger than dimension L2. The shape of case 200 (the relation in magnitude among the respective dimensions in the directions) is not limited to the above-described example. For example, case 200 may be formed in a rectangular parallelepiped shape long in the Y direction.

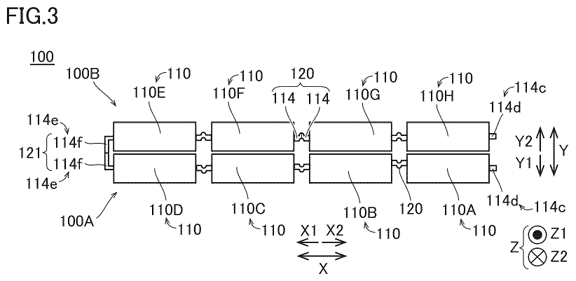

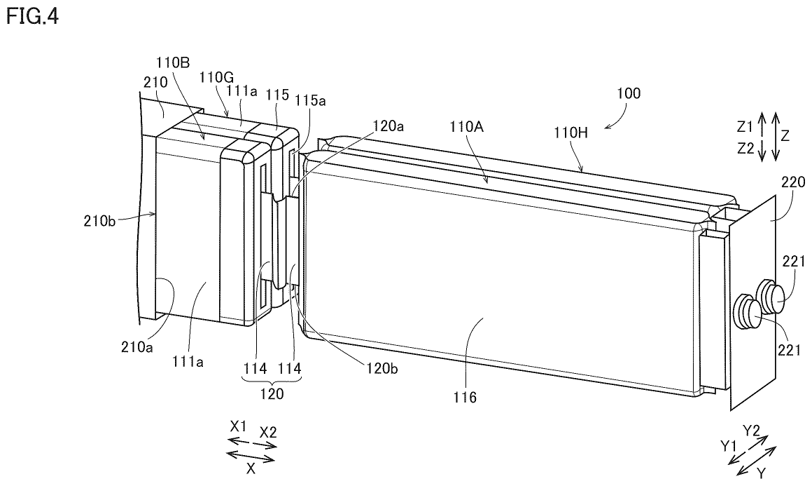

As illustrated in FIG. 3, cell assembly 100 includes a plurality of power storage cells 110. In the present embodiment, the number of power storage cells 110 is eight. However, the number of power storage cells 110 is not limited to eight. Examples of each power storage cell 110 include a lithium ion battery. Each power storage cell 110 may be composed of a so-called all-solid-state battery that includes a solid electrolyte. Each of the plurality of power storage cells 110 has a shape extending so as to be longer in the X direction than in the Y direction and longer in the X direction than in the Z direction. That is, each of the plurality of power storage cells 110 has a longitudinal direction in the X direction. Each of the plurality of power storage cells 110 has a shape extending so as to be longer in the Z direction than in the Y direction. In FIG. 3 and FIG. 4 described later, an elastic member 140 described later is not illustrated for simplification.

The eight power storage cells 110 are electrically connected in series. Specifically, the eight power storage cells 110 include a power storage cell 110A, a power storage cell 110B, a power storage cell 110C, a power storage cell 110D, a power storage cell 110E, a power storage cell 110F, a power storage cell 110G, and a power storage cell 110H.

Cell assembly 100 includes a first cell assembly 100A and a second cell assembly 100B. First cell assembly 100A is constituted of power storage cells 110A to 110D. Second cell assembly 100B is constituted of power storage cells 110E to 110H. Power storage cells 110A to 110D are arranged in the X direction (the longitudinal direction of each power storage cell 110). Specifically, power storage cell 110A, power storage cell 110B, power storage cell 110C, and power storage cell 110D are arranged in this order from the X2 side. Power storage cells 110E to 110H are arranged in the X direction. Specifically, power storage cell 110E, power storage cell 110F, power storage cell 110G, and power storage cell 110H are arranged in this order from the X1 side.

The row of power storage cells 110A to 110D (first cell assembly 100A) and the row of power storage cells 110E to 110H (second cell assembly 100B) are adjacent to each other in the Y direction. Specifically, power storage cell 110A and power storage cell 110H are adjacent to each other in the Y direction. Power storage cell 110B and power storage cell 110G are adjacent to each other in the Y direction. Power storage cell 110C and power storage cell 110F are adjacent to each other in the Y direction. Power storage cell 110D and power storage cell 110E are adjacent to each other in the Y direction.

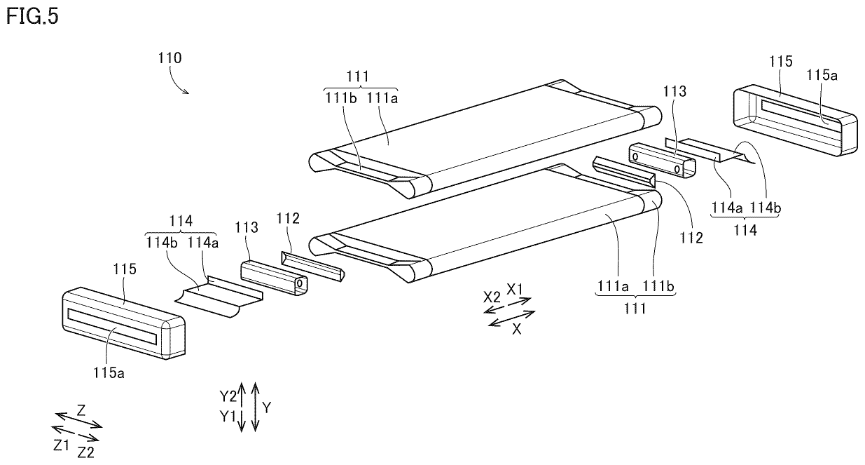

Power storage cells 110 adjacent to each other in the X direction are electrically connected in series by a connection portion 120. Connection portion 120 is a portion where current collector terminals 114 (protruding portions 114b) are connected to each other, each current collector terminal 114 including a connection portion 114a (FIG. 5) and protruding portion 114b (FIG. 5) described later. Connection portion 120 that electrically connects power storage cells 110 adjacent to each other in the X direction in first cell assembly 100A is an example of the “first connection portion” according to the present disclosure. Connection portion 120 that electrically connects power storage cells 110 adjacent to each other in the X direction in second cell assembly 100B is an example of the “second connection portion” according to the present disclosure.

A current collector terminal 114c is provided on an end portion of each of power storage cell 110A and power storage cell 110H on the X2 side. A protruding portion 114d of current collector terminal 114c is electrically connected to an external terminal 221 (FIG. 4). Protruding portion 114d of current collector terminal 114c extends linearly in the X direction.

A current collector terminal 114e is provided on an end portion of each of power storage cell 110D and power storage cell 110E on the X1 side. A protruding portion 114f of current collector terminal 114e of power storage cell 110D and a protruding portion 114f of current collector terminal 114e of power storage cell 110E are electrically connected to each other in a connection portion 121. Protruding portion 114f of current collector terminal 114e has an L shape. Thus, connection portion 121 has a U shape in which the X1 side corresponds to the lower side thereof.

Referring to FIG. 4, case 200 includes a case body 210 and a cover member 220. Case body 210 is formed in a rectangular tube shape long in the X direction.

Case 200 (case body 210) is provided with an opening 210a. Opening 210a is provided in an end portion 210b of case body 210 on the X2 side. Cover member 220 is joined to end portion 210b of case body 210 by welding or the like so as to close end portion 210b (opening 210a).

External terminal 221 is provided on cover member 220. External terminal 221 is provided so as to protrude from cover member 220 toward the X2 side.

FIG. 5 is an exploded perspective view of power storage cell 110. Referring to FIG. 5 together with FIG. 4, each power storage cell 110 includes at least one electrode assembly 111, a spacer 112, a terminal member 113, current collector terminal 114, a cover 115, and a laminate exterior package 116 (FIG. 4). In FIG. 5, laminate exterior package 116 is not illustrated. In FIG. 4, laminate exterior package 116 of power storage cell 110B and laminate exterior package 116 of power storage cell 110G are not illustrated.

In this example, power storage cell 110 includes two electrode assemblies 111. However, the number of electrode assemblies 111 is not limited to two. Each electrode assembly 111 is formed by a wound body in which a positive electrode sheet and a negative electrode sheet are wound with a separator interposed therebetween. However, each electrode assembly 111 may be formed by a stack in which a positive electrode sheet and a negative electrode sheet are stacked with a separator interposed therebetween. Two electrode assemblies 111 are adjacent to each other in the Y direction in which the positive electrode sheet and the negative electrode sheet are stacked on each other. Each electrode assembly 111 is formed in a shape long in the X direction.

Each electrode assembly 111 includes a coated portion 111a and an electrode tab 111b. Coated portion 111a is a region of an electrode foil in the positive electrode sheet or the negative electrode sheet where an active material layer is provided. Electrode tab 111b is a region of the electrode foil in the positive electrode sheet or the negative electrode sheet where the active material layer is not provided (i.e. an uncoated portion where the electrode foil is exposed).

Spacer 112 is disposed between a pair of electrode tabs 111b adjacent to each other. Spacer 112 is made of an electrically insulating material (such as a synthetic resin). Spacer 112 has a shape in which the dimension in the Y direction becomes larger with an increase in the distance from coated portion 111a in the X direction.

Terminal member 113 is connected to an outer side surface of spacer 112 in the X direction. Terminal member 113 is made of an electrically conductive material (metal such as copper or aluminum). Terminal member 113 is connected to the pair of electrode tabs 111b adjacent to each other in the Y direction.

Current collector terminal 114 is connected to terminal member 113. Current collector terminal 114 electrically connected, via terminal member 113, to electrode tab 111b as a positive electrode tab is made of aluminum for example. Current collector terminal 114 electrically connected, via terminal member 113, to electrode tab 111b as a negative electrode tab is made of copper for example. Current collector terminal 114 includes connection portion 114a and protruding portion 114b.

Connection portion 114a is connected to an outer side surface of terminal member 113 in the X direction by welding or the like. Connection portion 114a is formed in a flat plate shape. Protruding portion 114b protrudes outward in the X direction from connection portion 114a.

Cover 115 covers an end portion (electrode tab 111b) of electrode assembly 111 in the X direction. Cover 115 is made of an electrically insulating material (such as a synthetic resin). Cover 115 is provided with a through hole 115a through which protruding portion 114b is inserted.

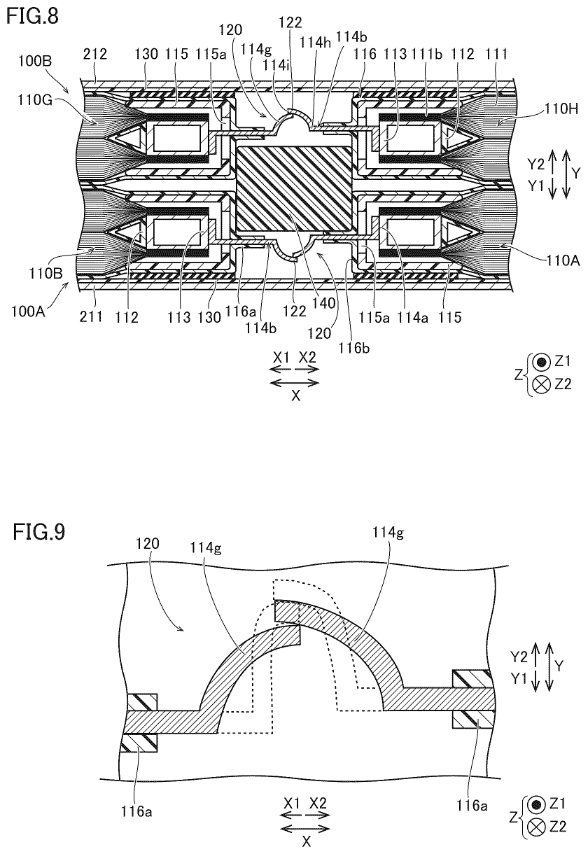

Laminate exterior package 116 (FIG. 4) accommodates each electrode assembly 111, spacer 112, terminal member 113, part of current collector terminal 114, and cover 115. Laminate exterior package 116 is formed by a laminate film. Laminate exterior package 116 includes an edge portion 116a (FIG. 8). Edge portion 116a is formed by connecting (welding) the laminate films to each other. Protruding portion 114b protrudes from edge portion 116a of laminate exterior package 116.

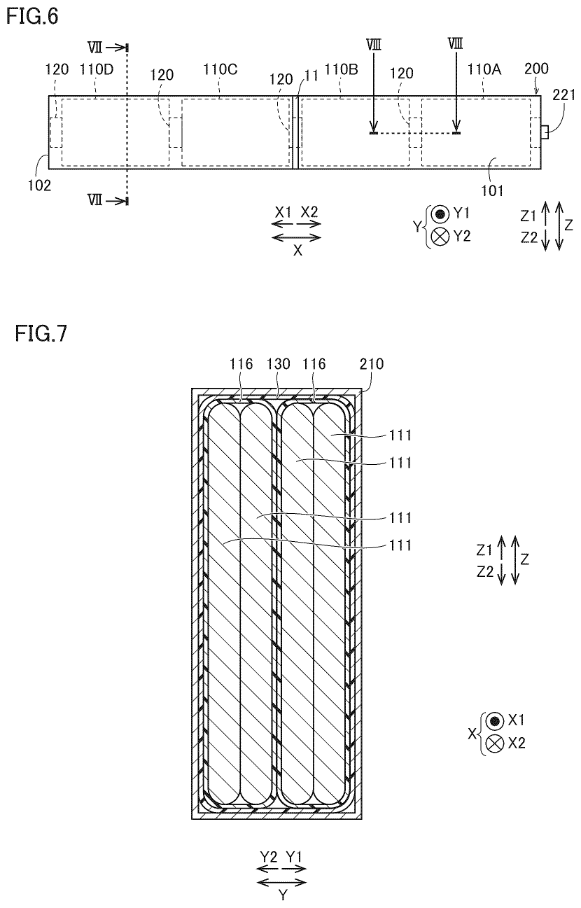

FIG. 6 is a side view of power storage device 1 viewed from the Y1 side. In FIG. 6, cell assembly 100 accommodated in case 200 is indicated by dashed lines.

FIG. 7 is a cross-sectional view along line VII-VII in FIG. 6. Cell assembly 100 includes a cover sheet 130. Cover sheet 130 is accommodated in case 200. Case body 210 surrounds the plurality of power storage cells 110 and cover sheet 130. Cover sheet 130 is made of an electrically insulating material (such as a synthetic resin).

In a conventional power storage device, a plurality of power storage cells are connected in series in a predetermined direction and thus, when a shock is applied to one of the power storage cells, the shock may be easily transmitted to another one of the power storage cells.

In the present embodiment, a shock absorbing portion is provided between power storage cells 110 electrically connected by connection portion 120. The shock absorbing portion includes a bent portion 122 (FIG. 8) formed in connection portion 120. The details are described below with reference to FIG. 8. Bent portion 122 is an example of the “bent portion” and the “expansion and contraction portion” according to the present disclosure.

FIG. 8 is a partial cross-sectional view illustrating, on an enlarged scale, the vicinity of connection portion 120 between power storage cell 110A and power storage cell 110B and connection portion 120 between power storage cell 110G and power storage cell 110H. Each of the other connection portions 120 also has the same configuration as that of connection portion 120 illustrated in FIG. 8.

Connection portion 120 is made up of respective protruding portions 114b of two power storage cells 110 adjacent to each other in the X direction. Protruding portion 114b includes a bent portion 114g. Protruding portion 114b is bent toward the Y1 side or the Y2 side from a starting point portion 114h. Bent portion 114g is a portion between starting point portion 114h and a distal end portion 114i (an open-side end portion) of protruding portion 114b. Bent portion 122 of connection portion 120 in first cell assembly 100A is an example of the “first bent portion” according to the present disclosure. Bent portion 122 of connection portion 120 in second cell assembly 100B is an example of the “second bent portion” according to the present disclosure.

Respective bent portions 114g of two power storage cells 110 adjacent to each other in the X direction are joined together in connection portion 120. Specifically, the portions in the vicinity of distal end portions 114i overlap each other in the Y direction.

Each of the plurality of bent portions 114g provided in first cell assembly 100A (power storage cells 110A to 110D) is bent toward the Y1 side. Accordingly, bent portion 122 formed in first cell assembly 100A is formed so as to project toward the Y1 side. Bent portion 122 of first cell assembly 100A is formed so as to project toward a side surface 211 of case 200 (case body 210) on the Y1 side.

Each of the plurality of bent portions 114g provided in second cell assembly 100B (power storage cells 110E to 110H) is bent toward the Y2 side. Accordingly, bent portion 122 formed in second cell assembly 100B is formed so as to project toward the Y2 side. Bent portion 122 of second cell assembly 100B is formed so as to project toward a side surface 212 of case 200 (case body 210) on the Y2 side.

Thus, bent portion 122 of first cell assembly 100A is bent so as to project in a direction away from bent portion 122 of second cell assembly 100B. Further, bent portion 122 of second cell assembly 100B is bent so as to project in a direction away from bent portion 122 of first cell assembly 100A. That is, bent portion 122 of first cell assembly 100A and bent portion 122 of second cell assembly 100B are formed so as to project in the opposite directions of each other (the directions away from each other).

Bent portion 122 has a semicircular shape when viewed from the Z1 side. The shape of bent portion 122 is not limited to this example. For example, bent portion 122 may have a triangular shape or a quadrangular shape when viewed from the Z1 side.

Bent portion 122 of first cell assembly 100A and bent portion 122 of second cell assembly 100B are disposed in the same positions in the X direction. In cell assembly 100, sets of bent portions 122, in each of which bent portions 122 are disposed in the same positions in the X direction, are provided in a plurality of positions (for example, three positions) in the X direction.

As illustrated in FIG. 9, bent portion 122 expands and contracts in the X direction when a shock is applied to power storage cell 110 or the like from the outside. When the gap between power storage cells 110 adjacent to each other in the X direction is caused to vary by the shock from the outside, the width of bent portion 122 in the X direction varies and the dimension of bent portion 122 in the Y direction varies. For example, bent portion 122 deforms from the shape indicated by the solid line in FIG. 9 to the shape indicated by the dashed lines in FIG. 9 when a shock is applied from the outside such that the gap between power storage cells 110 decreases. That is, the bending amount of bent portion 122 increases. When force in the opposite direction of the above-described direction is applied from the outside, bent portion 122 deforms from the shape indicated by the dashed lines in FIG. 9 to the shape indicated by the solid line in FIG. 9. That is, the bending amount of bent portion 122 decreases. Thus, a shock from the outside is absorbed by the change in the shape (the change in the bending amount) of bent portion 122. As a result, the shock from the outside is alleviated (absorbed) and transmission of the shock between power storage cells 110 is inhibited.

Bent portion 122 is provided so as to extend from an end portion 120a (FIG. 4) of connection portion 120 on the Z1 side to an end portion 120b of connection portion 120 on the Z2 side. In other words, bent portion 122 is formed in the entire region of connection portion 120 in the Z direction.

Referring again to FIG. 8, the shock absorbing portion includes an elastic member 140 (such as a rubber member, a spring, or the like). Elastic member 140 is provided between power storage cells 110 adjacent to each other in the X direction. For example, elastic member 140 may be sandwiched between power storage cells 110 adjacent to each other in the X direction. Specifically, elastic member 140 may be sandwiched between respective end surfaces 116b of laminate exterior packages 116 of power storage cells 110. End surface 116b is an end surface of laminate exterior package 116 in the X direction.

Elastic member 140 extends in the Y direction so as to straddle on first cell assembly 100A and second cell assembly 100B. Elastic member 140 is disposed between connection portion 120 of first cell assembly 100A and connection portion 120 of second cell assembly 100B.

Although not illustrated, for example, elastic member 140 may extend, in the Z direction, from the position of end portion 120a (FIG. 4) of connection portion 120 to the position of end portion 120b (FIG. 4) of connection portion 120. Elastic member 140 may extend, in the Z direction, from the position of the end surface of power storage cell 110 on the Z1 side to the position of the end surface of power storage cell 110 on the Z2 side.

As described above, in the present embodiment, the shock absorbing portion is provided between power storage cells 110 electrically connected by connection portion 120. Thus, transmission of a shock between power storage cells 110 is inhibited by the shock absorbing portion. As a result, chain transmission of a shock in cell assembly 100 can be inhibited.

In the present embodiment, the shock absorbing portion includes bent portion 122 formed in connection portion 120. That is, transmission of a shock to power storage cell 110 is inhibited by the shape (the bending shape) of connection portion 120. Accordingly, transmission of a shock to power storage cell 110 can be inhibited while hampering an increase in the number of components. In addition, the length of connection portion 120 can be made large in comparison with the case where connection portion 120 has a linear shape. As a result, a shock can be absorbed more effectively by connection portion 120.

Although an example in which the shock absorbing portion includes bent portion 122 formed in connection portion 120 is shown in the above-described embodiment, the present disclosure is not limited thereto. A portion other than the bent portion formed in the connection portion may be provided as the shock absorbing portion.

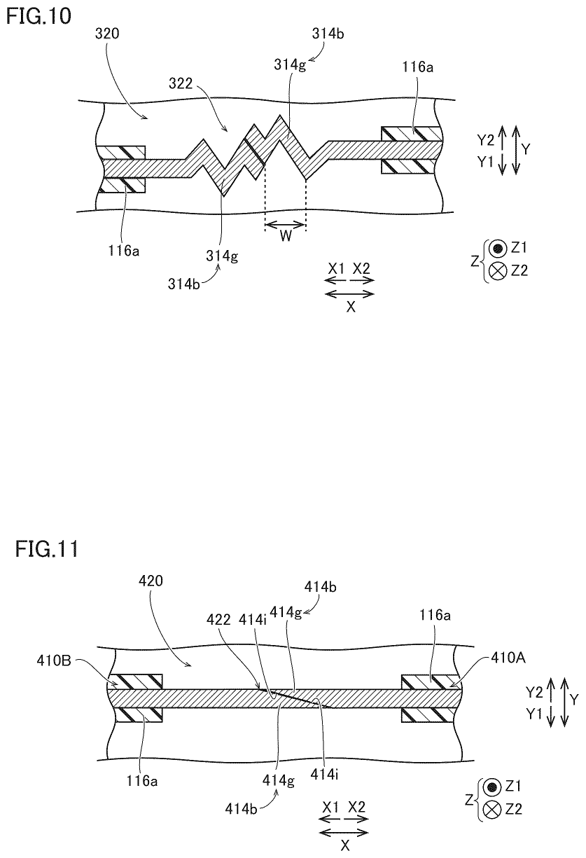

For example, in the example shown in FIG. 10, an expansion and contraction portion 322 is formed as the shock absorbing portion in a connection portion 320. Expansion and contraction portion 322 is formed so as to be expandable and contractible in the X direction. Specifically, a protruding portion 314b includes a bellows portion 314g. Expansion and contraction portion 322 is formed by joining together respective protruding portions 314b (bellows portions 314g) of the power storage cells adjacent to each other in the X direction. Bellows portion 314g expands and contracts in the X direction due to a shock from the outside, and expansion and contraction portion 322 expands and contracts in the X direction accordingly. The expansion and contraction of bellows portion 314g in the X direction denotes that a folding width W of bellows portion 314g varies. Expansion and contraction portion 322 is an example of the “bent portion” and the “expansion and contraction portion” according to the present disclosure.

In the example shown in FIG. 11, a power storage cell 410A and a power storage cell 410B are illustrated. Each of power storage cell 410A and power storage cell 410B includes a protruding portion 414b. Protruding portion 414b of power storage cell 410A and protruding portion 414b of power storage cell 410B are electrically connected to each other by a connection portion 420. Protruding portion 414b includes a tapering portion 414g. Tapering portion 414g of power storage cell 410A tapers toward power storage cell 410B. Tapering portion 414g of power storage cell 410B tapers toward power storage cell 410A. Power storage cell 410A and power storage cell 410B are respective examples of the “first power storage cell” and the “second power storage cell” according to the present disclosure. Protruding portion 414b of power storage cell 410A is an example of the “first electrode terminal” according to the present disclosure. Protruding portion 414b of power storage cell 410B is an example of the “second electrode terminal” according to the present disclosure. Tapering portion 414g of power storage cell 410A is an example of the “first tapering portion” according to the present disclosure. Tapering portion 414g of power storage cell 410B is an example of the “second tapering portion” according to the present disclosure.

Tapering portion 414g of power storage cell 410A and tapering portion 414g of power storage cell 410B are connected to each other in a portion 422. Portion 422 functions as the shock absorbing portion between power storage cell 410A and power storage cell 410B. Portion 422 is formed by respective sloping surfaces 414i of tapering portions 414g in contact with each other.

Although an example in which elastic member 140 is disposed between connection portions 120 is shown in the above-described embodiment, the present disclosure is not limited thereto. A portion other than elastic member 140 may be disposed between connection portions 120.

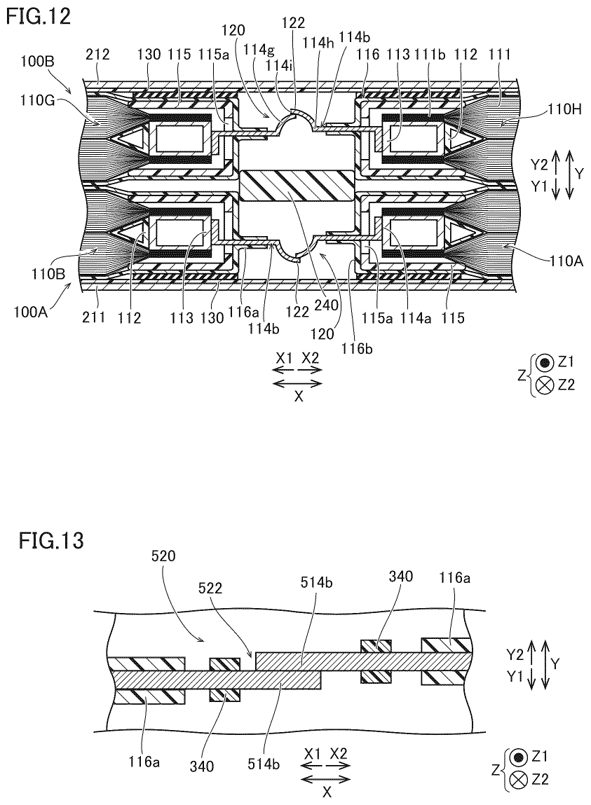

In the example shown in FIG. 12, a damper 240 is disposed between connection portions 120 (bent portions 122) arranged in the Y direction. Damper 240 is formed of, for example, an electrically insulating resin. Damper 240 is disposed in the center between connection portions 120 (bent portions 122). Damper 240 is formed so as to extend in the X direction. Specifically, damper 240 is formed so as to be longer in the X direction than bent portion 122. In the X direction, damper 240 extends at least across the entire range in which bent portion 122 is provided. In the example shown in FIG. 12, damper 240 is provided so as to be sandwiched between power storage cells 110 adjacent to each other in the X direction. Although only one damper 240 is provided in FIG. 12, a plurality of dampers 240 may be provided. An electrically insulating member other than damper 240 may be provided. Damper 240 is an example of the “electrically insulating member” according to the present disclosure.

Although an example in which protruding portion 114b is in contact only with the other protruding portion 114b is shown in the above-described embodiment, the present disclosure is not limited thereto. Protruding portion 114b may be in contact with another member.

In the example shown in FIG. 13, a protruding portion 514b is held by a holding member 340. Holding member 340 is formed of, for example, an electrically insulating and elastically deformable resin or the like. Although protruding portion 514b is formed in a linear shape in the example shown in FIG. 13, a bent portion having a bent shape, a bellows shape, or a tapering shape may be held by holding member 340 as in the above-described embodiment or variations thereof.

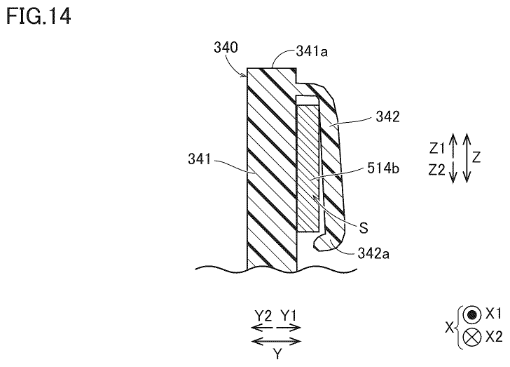

FIG. 14 shows a cross-sectional view of holding member 340. Holding member 340 includes a support portion 341 and a clip portion 342. Support portion 341 extends in the Z direction. Clip portion 342 is formed so as to extend to the Z2 side from the vicinity of an end portion 341a of support portion 341 on the Z1 side. When force is applied toward the Y1 side, clip portion 342 is deformed so as to bend toward the Y1 side. Clip portion 342 returns to its original shape when the force is removed. That is, clip portion 342 is formed so as to be elastically deformable.

A space S is provided between support portion 341 and clip portion 342. Protruding portion 514b is sandwiched between clip portion 342 and support portion 341 by being placed in space S. At this time, protruding portion 514b is sandwiched between clip portion 342 and support portion 341 owing to the elastic force of clip portion 342. Thus, protruding portion 514b is held by holding member 340. A retaining portion 342a for inhibiting protruding portion 514b from coming off from space S is provided in an end portion of clip portion 342 on the Z2 side.

The shape of the member that holds the protruding portion is not limited to the above-described example. For another example, the protruding portion may be held by a member that is not elastically deformed.

Although an example in which each of bent portion 122 and elastic member 140 functions as the shock absorbing portion is shown in the above-described embodiment, the present disclosure is not limited thereto. One of bent portion 122 and elastic member 140 may be dispensed with.

Although an example in which the number of rows of power storage cells 110 arranged in the X direction is two is shown in the above-described embodiment, the present disclosure is not limited thereto. The number of rows of power storage cells 110 arranged in the X direction may be one or be three or more.

Although an example in which bent portion 122 on the Y1 side and bent portion 122 on the Y2 side are formed so as to project in the opposite directions of each other (the directions away from each other) is shown in the above-described embodiment, the present disclosure is not limited thereto. Bent portion 122 on the Y1 side and bent portion 122 on the Y2 side may be formed so as to project in the same direction. Bent portion 122 on the Y1 side may be formed so as to project toward bent portion 122 on the Y2 side while bent portion 122 on the Y2 side may be formed so as to project toward bent portion 122 on the Y1 side.

Although an example in which bent portion 122 extends from end portion 120a (FIG. 4) of connection portion 120 on the Z1 side to end portion 120b (FIG. 4) of connection portion 120 on the Z2 side is shown in the above-described embodiment, the present disclosure is not limited thereto. For example, bent portion 122 may be provided only in a lower portion of connection portion 120 (e.g. a portion under the center of connection portion 120 in the Z direction).

Although an example in which the plurality of power storage cells 110 are connected to each other in the X direction (the front-rear direction of electrically powered vehicle 900) by connection portions 120 is shown in the above-described embodiment, the present disclosure is not limited thereto. The plurality of power storage cells 110 may be connected in the Y direction (the left-right direction of electrically powered vehicle 900) by connection portions 120.

Although an example in which power storage device 1 is mounted on electrically powered vehicle 900 is shown in the above-described embodiment, the present disclosure is not limited thereto. Power storage device 1 may be provided in an electric device other than the electrically powered vehicle (for example, a stationary power storage device).

Although an example in which bent portion 122 expands and contracts in the X direction is shown in the above-described embodiment, the present disclosure is not limited thereto. Bent portion 122 is not necessarily required to expand and contract in the X direction. Similarly, expansion and contraction portion 322 illustrated in FIG. 10 is not necessarily required to expand and contract in the X direction. Further, the protruding portion formed so as to extend linearly in the X direction may be configured so as to expand and contract in the X direction.

Although an example in which bent portion 122 is formed by joining two protruding portions 114b together is shown in the above-described embodiment, the present disclosure is not limited thereto. The power storage cells adjacent to each other in the X direction may be electrically connected to each other by a single metal plate, and the metal plate may be provided with the bent portion.

Although an example in which the set of power storage cells 110A to 110D and the set of power storage cells 110E to 110H are each arranged in the longitudinal direction of power storage cells 110 is shown in the above-described embodiment, the present disclosure is not limited thereto. Power storage cells 110A to 110D (110E to 110H) may be arranged in the lateral direction of power storage cells 110.

The configurations in the above-described embodiment and variations thereof may be combined with each other.

Although embodiments of the present disclosure have been described, it should be understood that the herein-disclosed embodiments are presented by way of illustration and example in all respects and are not to be taken by way of limitation. The scope of the present disclosure is defined by the claims and intended to include all changes within the purport and scope equivalent to the claims.

What is claimed is:

1. A power storage device comprising:
a cell assembly including a plurality of power storage cells arranged in an arrangement direction and a connection portion electrically connecting the power storage cells adjacent to each other in the arrangement direction; and
a case that accommodates the cell assembly, wherein
a shock absorbing portion is provided between the power storage cells electrically connected by the connection portion.

2. The power storage device according to claim 1, wherein each of the plurality of power storage cells has a longitudinal direction in the arrangement direction.

3. The power storage device according to claim 1, wherein the shock absorbing portion includes a bent portion formed in the connection portion.

4. The power storage device according to claim 3, wherein
the cell assembly includes a first cell assembly and a second cell assembly adjacent to each other in an orthogonal direction orthogonal to the arrangement direction,
the connection portion includes
a first connection portion electrically connecting the power storage cells adjacent to each other in the arrangement direction in the first cell assembly, and
a second connection portion electrically connecting the power storage cells adjacent to each other in the arrangement direction in the second cell assembly, and
the bent portion includes
a first bent portion formed in the first connection portion, and
a second bent portion formed in the second connection portion.

5. The power storage device according to claim 4, wherein in the orthogonal direction, the first bent portion is bent so as to project in a direction away from the second bent portion.

6. The power storage device according to claim 5, wherein in the orthogonal direction, the second bent portion is bent so as to project in a direction away from the first bent portion.

7. The power storage device according to claim 4, further comprising an electrically insulating member disposed between the first bent portion and the second bent portion.

8. The power storage device according to claim 1, wherein the shock absorbing portion includes an expansion and contraction portion formed in the connection portion and capable of expanding and contracting in the arrangement direction.

9. The power storage device according to claim 1, wherein the shock absorbing portion includes an elastic member disposed between the power storage cells electrically connected by the connection portion.

10. The power storage device according to claim 1, wherein
the plurality of power storage cells include a first power storage cell and a second power storage cell electrically connected by the connection portion,
the first power storage cell includes a first electrode terminal protruding toward the second power storage cell,
the second power storage cell includes a second electrode terminal protruding toward the first power storage cell,
the first electrode terminal and the second electrode terminal are electrically connected to each other by the connection portion,
the first electrode terminal includes a first tapering portion tapering toward the second power storage cell,
the second electrode terminal includes a second tapering portion tapering toward the first power storage cell and connected to the first tapering portion, and
the shock absorbing portion includes a portion where the first tapering portion and the second tapering portion are connected to each other.

11. The power storage device according to claim 1, wherein the shock absorbing portion includes a holding member that holds the connection portion.
